(19) United States
(12) Patent Application Publication
(10) Pub. No.: US 2009/0297311 A1
(43) Pub. Date: Dec. 3, 2009

(54) TRUCK ADAPTED FOR LATERAL DISTRIBUTION OF BULK MATERIALS

(76) Inventor: Donald L. Mensch, Byron Center, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/429,307

(22) Filed: Apr. 24, 2009

Related U.S. Application Data
(60) Provisional application No. 61/057,016, filed on May 29, 2008.

(51) Int. Cl. B60P 1/00

(52) U.S. Cl. 414/502

(57) ABSTRACT

A material-handling vehicle includes a wheeled vehicle with front-located cabin; a compartment for holding bulk flowable material; a longitudinal conveyor with beam-style agitator for moving material from the compartment to the vehicle's front; a transverse conveyor for selectively distributing the material laterally in right or left directions and also the trajectory of the material, with lateral discharge visible from the cabin; central pivot structure on a longitudinal centerline of the wheeled vehicle for pivotally supporting the transverse conveyor for movement to different angular positions; actuators operably connected to the transverse conveyor for controlling angular movement thereof; and a control in the cabin for controlling operation of the at least on actuator. Tunnel covers focus the lateral discharge.

This application claims benefit under 35 U.S.C. §119(e) of provisional application Ser. No. 61/057,016, filed May 29, 2008, entitled TRUCK ADAPTED FOR LATERAL DISTRIBUTION OF BULK MATERIALS, the entire contents of which are incorporated herein in their entirety.

### BACKGROUND

The present invention relates to trucks and self-propelled material-handling apparatus for accurate lateral distribution of bulk material, such as bedding and/or food for animals, fertilizer and/or chemicals and/or ground cover for plants, and the like.

Animal farms, orchard farms, and many “outdoor” industries (such as highway, building and landscaping businesses) often have a need to distribute material accurately, evenly, and quickly. Two examples would be bedding and food for cattle (in the dairy industry) and ground cover, fertilizer and chemicals for trees (in the highway and/or orchard industry). A problem is that known equipment is expensive, more complicated than desired, less durable than desired, not easily maintained, and further the distribution of material is not as controllable and/or efficient and/or accurate and/or uniform as desired. Part of the problem is poor visibility by the vehicle driver, such that even if the driver has the ability to control operation of the equipment, the driver does not have sufficient visibility to see what needs to be adjusted. Another problem is accuracy of the distribution area as the material is unloaded.

### SUMMARY OF THE PRESENT INVENTION

In one aspect of the present invention, a material-handling vehicle includes a steerable self-propelled vehicle including a front-located control cabin, an upwardly-open compartment on the vehicle for receiving and holding bulk material, and a longitudinal conveyor for motivating the bulk material toward a front of the vehicle. The vehicle further includes a transverse conveyor at a front of the longitudinal conveyor for receiving the bulk material from the longitudinal conveyor and for selectively distributing the material laterally in right or left directions in patterns visible from the cabin, pivot structure on the wheeled vehicle operably supporting the transverse conveyor for adjustable movement about a central pivot axis to different angular positions, at least one actuator operably connected to the transverse conveyor for adjusting the transverse conveyor to one of the angular positions, and a control in the cabin for controlling operation of the at least one actuator.

In another aspect of the present invention, a material-handling vehicle includes a vehicle including a front-located control cabin, an upwardly-open compartment on the vehicle for receiving and holding bulk material, and a longitudinal conveyor for motivating the bulk material toward a front of the vehicle. The vehicle further includes a transverse conveyor at a front of the longitudinal conveyor for receiving the bulk material from the longitudinal conveyor and for selectively distributing the material laterally in right or left directions in patterns visible from the cabin, structure for adjusting an angular position of the transverse conveyor, and at least one guard attached to ends of the transverse conveyor and forming a tunnel over the ends to better direct and control bulk material being distributed by the transverse conveyor.

In another aspect of the present invention, a material-handling vehicle includes a vehicle including a front-located control cabin, an upwardly-open elongated compartment on the vehicle for receiving and holding bulk material, and a longitudinal conveyor for motivating the bulk material toward a front of the vehicle. The vehicle further includes a transverse conveyor at a front of the longitudinal conveyor for receiving the bulk material from the longitudinal conveyor and for selectively distributing the material laterally in right or left directions in patterns visible from the cabin, structure for adjusting an angular position of the transverse conveyor, and an agitator in the compartment for breaking up bulk material forming a bridge between sides of the compartment, the agitator including a rotatable beam spaced above a floor of the compartment and arms extending radially from the beam.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are front right-hand and left-hand perspective view of a material-handling truck embodying the present inventive concepts.

FIGS. 3-6 are top, right side, front, and left side views of the truck in FIG. 1.

FIG. 7 is a fragmentary perspective view inside the container of the truck bed from a rear area looking forwardly, and FIG. 7A is a perspective view of the agitation system in FIG. 7.

FIGS. 8-9 are front views of FIG. 1 showing different angled positions of the transverse conveyor for “aimed” distribution of bulk material from the truck.

FIG. 10 is a perspective view similar to FIG. 1 but with the transverse conveyor removed to show underlying components.

### DETAILED DESCRIPTION OF PREFERRED EMBODIMENTS

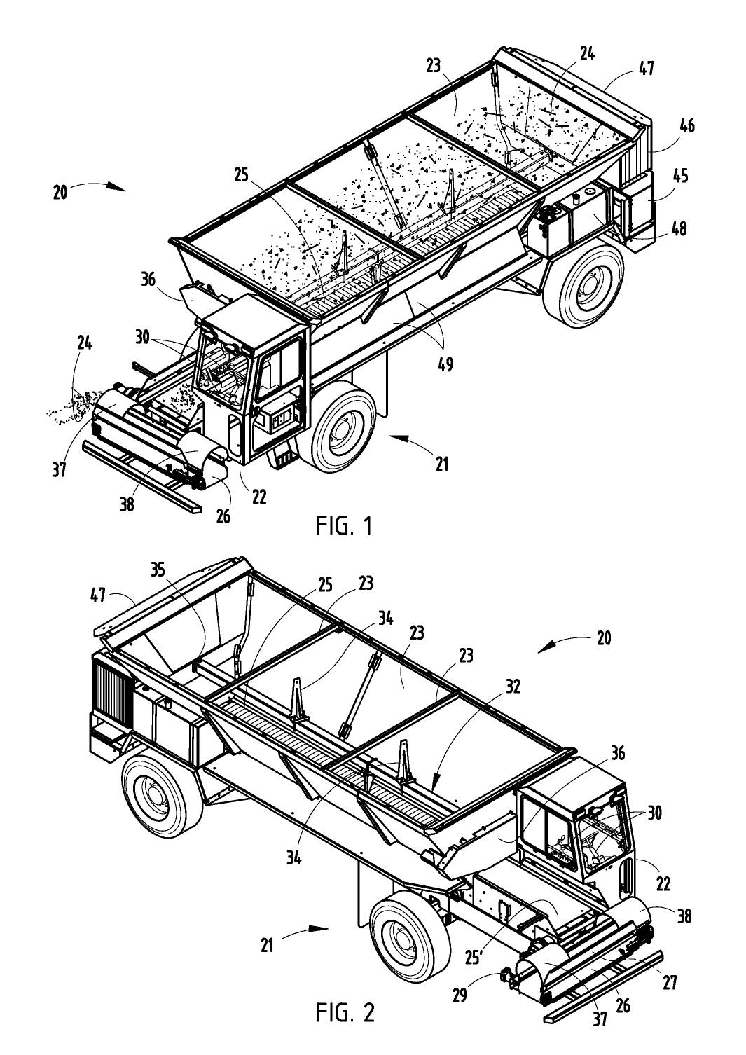

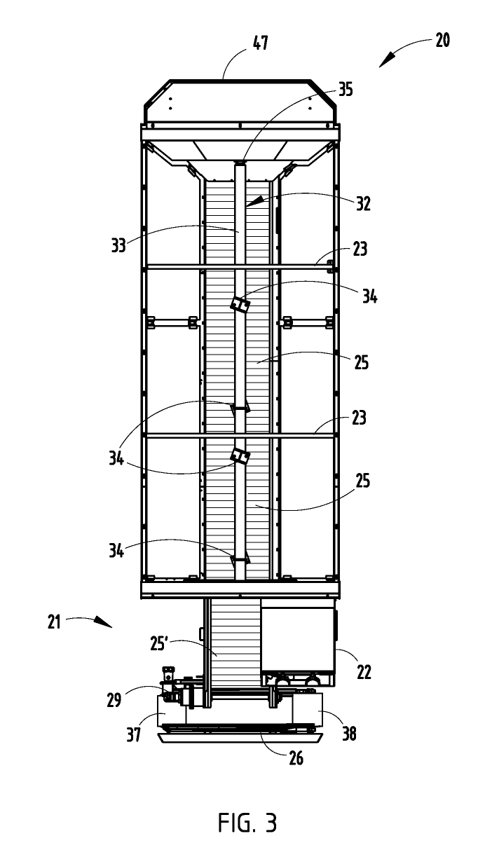

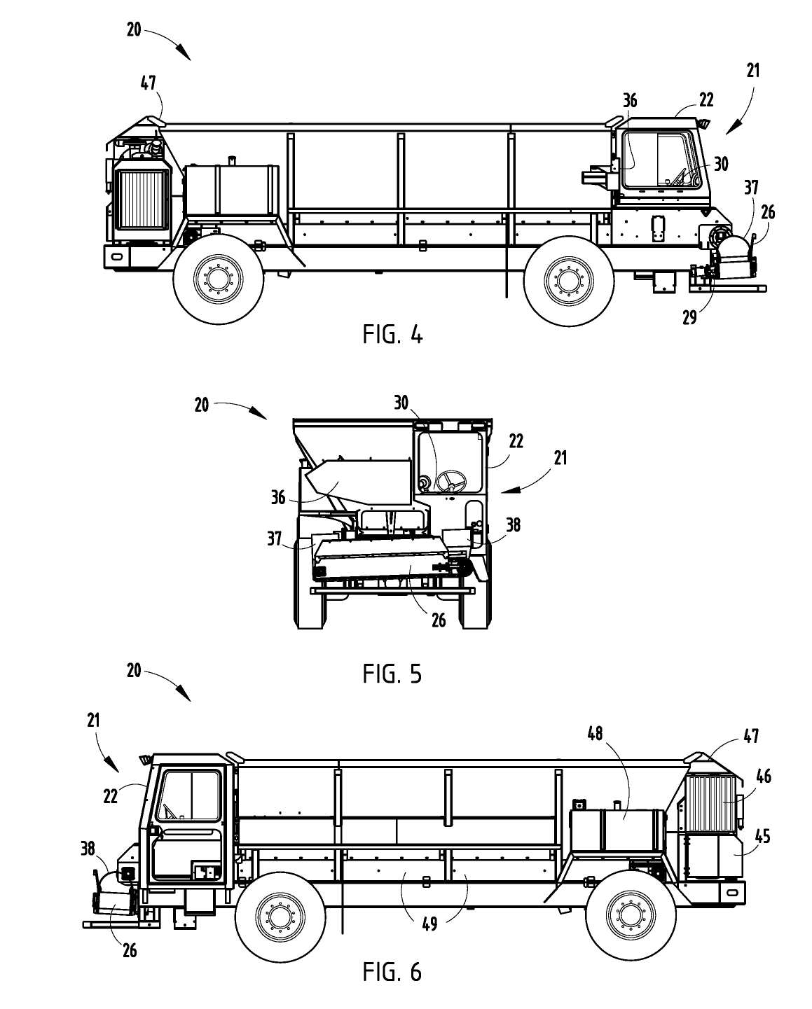

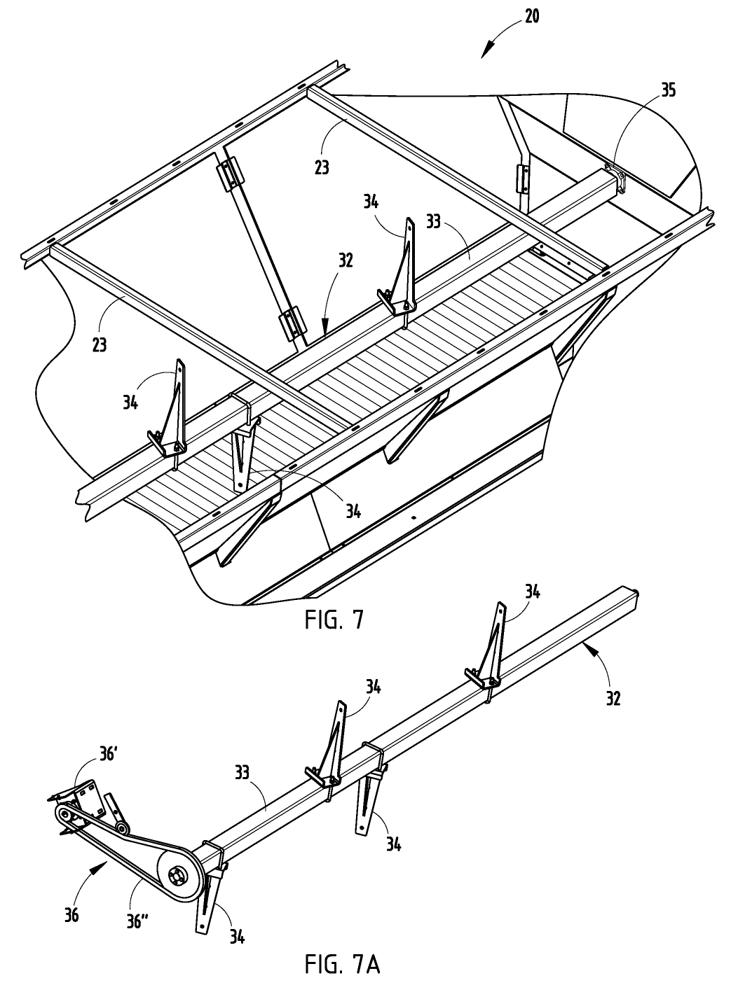

A material-handling vehicle 20 (FIGS. 1-6) includes a self-powered steerable-wheeled vehicle frame 21 with a front-located cabin 22 positioned for excellent visibility by a vehicle driver during distribution of bulk product/material 24, as described below. An upwardly-open compartment 23 is mounted on the vehicle 20 for holding the bulk flowable material 24. A longitudinal conveyor 25 with drive motor 25′ is included for motivating the material 24 from the compartment 23 to a front of the vehicle 20, and a transverse conveyor 26 is positioned at a front of the longitudinal conveyor 25 for receiving the material 24 from the longitudinal conveyor 25 and distributing the material 24 laterally in either direction. An agitator 32 is mounted longitudinally in the compartment 23, and includes a pole-like beam 33 with finger-like arms 34 extending radially. Notably, the arms 34 can be as long or short as needed, and can be triangular/linear or spiral shaped. The ends of the beam 33 are supported by a rear bearing 35 on a rear wall of the compartment 23, and a front bearing (not specifically shown). A drive shaft extends through the front wall of the compartment 23 to a rotary drive unit 36 with pump motor 36′ and belt drive 36″ at its front end. The drive unit 36 can be a chain-driven construction covered by a sheet metal guard, . . . or can be another construction such as belt-driven, gear-driven, direct drive, etc. By this arrangement, the agitator 32 can be rotated to “break” any material bridging between the sides of the compartment 23. The speed of rotation of the agitator 32 can be adjusted to a suitable speed, such as about 60 rpm when used for bedding material for cattle. The illustrated beam 33 of agitator 32 is about 24 inches above a floor of the compartment 23, and the arms 34 are about 16 inches long and are triangular or pyramid-like in shape.

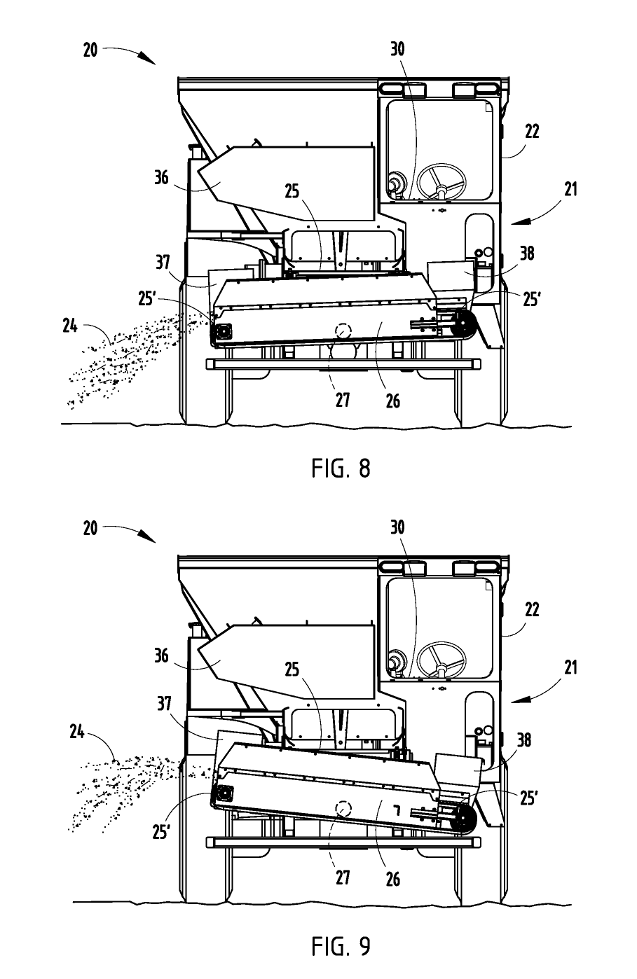

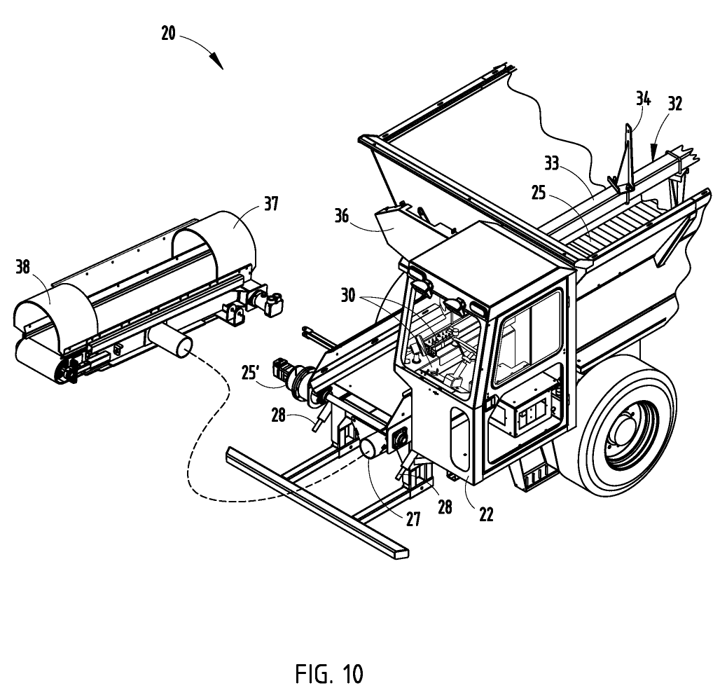

The transverse conveyor 26 (also called “lateral conveyor”) is mounted for angular adjustment (compare FIGS. 8-9) on a center pivot and support structure 27 (see FIG. 10) via actuators 28. The central location of the center pivot/support structure 27 provides a balance to the transverse conveyor 26 that makes adjustment easier and less wearing on the support structure 27. Further, the central location causes the input of bulk material 24 from the longitudinal conveyor 25 to transverse conveyor 26 to be at a relatively consistent height despite angular adjustment of a pitch of the transverse conveyor 26. Notably, the support structure 27 can include additional support on a front side of the transverse conveyor 26, such as a stanchion and bearing (not shown) extending upwardly from the front bumper/front end structure.

The transverse conveyor's motor drive 29 is speed-controlled and reversible, such that the conveyor 26 can be adjusted in angle, speed of belt operation, and right/left direction of belt operation. The forward and high position of the cabin 22 above the conveyor 26 allows excellent visibility to a vehicle driver. Controls are provided in the cabin 22 for controlling the conveyors 25 and 26, along with controlling all important aspects of the vehicle 20. Thus, the overall system can be controlled by a vehicle driver using controls 30 for accurately selectively distributing the material 24 laterally in right or left directions and also controlling the trajectory and speed of distribution. Testing has shown that the conveyor system can distribute bedding for livestock laterally up to 20 to 30 feet, and also can be used to distribute ground cover and/or fertilizer and/or chemicals sufficiently uniformly for orchard and landscape operations. The distributed bulk material 24 can be distributed accurately and at desired amounts, and with a desired level of uniformity, while operating the vehicle 20 at reasonably fast speeds of operation (such as 5-10 mph . . . or faster).

Control over the distributed material 24, as well as the accuracy of distribution and the uniformity/predictability of the distributed bulk materials 24 can potentially be improved by placing tunnel guards 37 and 38 on ends of the transverse conveyor 26. The illustrated guards 37, 38 have an inverted semi-cylindrical shape that forms a tunnel when attached to side walls of the conveyor 26. Testing shows that tunnel guards 37, 38 can be relatively short, such as from outer ends of the transverse conveyor 26 to a side wall of the longitudinal conveyor 25 (with a discharge opening for the conveyor 25 therebetween). However, it is contemplated that the guards 37, 38 can be any length desired, and for example can potentially extend a full length of the conveyor 26. In such case, the guard(s) would include or define an inlet side opening for receiving material 24 from the conveyor 25.

It is contemplated that a scope of the present inventive vehicle 20 can include a variety of different drive power plants, steering mechanisms, and cabin and control designs. The illustrated vehicle 20 (FIG. 2) includes a rear-positioned motor and power/drive mechanism 45, a radiator 46 with top shield 47 to protect against damage from material 24 being dumped into the compartment 23, a fuel tank 48, and control lines extending to cabin 22 along a side of the compartment 23 under shield covers 49. The illustrated wheeled frame 21 includes four steerable wheels (see FIG. 1) for tight cornering, and potentially can include an additional set of wheels under a center of the compartment 23, if desired/required.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A material-handling vehicle comprising:
a steerable self-propelled vehicle including a front-located control cabin;
an upwardly-open compartment on the vehicle for receiving and holding bulk material;
a longitudinal conveyor for motivating the bulk material toward a front of the vehicle;
a transverse conveyor at a front of the longitudinal conveyor for receiving the bulk material from the longitudinal conveyor and for selectively distributing the material laterally in right or left directions in patterns visible from the cabin;
pivot structure on the wheeled vehicle operably supporting the transverse conveyor for adjustable movement about a central pivot axis to different angular positions; and
at least one actuator operably connected to the transverse conveyor for adjusting the transverse conveyor to one of the angular positions, and a control in the cabin for controlling operation of the at least one actuator.

2. The vehicle defined in claim 1, wherein the transverse conveyor includes ends, and including at least one guard forming a tunnel over at least one of the ends for directing bulk material distributed from the one end.

3. The vehicle defined in claim 2, wherein the at least one guard includes separate tunnel guards over each of the ends and that are separated to define an opening for receiving bulk material from the longitudinal conveyor.

4. The vehicle defined in claim 1, including actuators on opposite sides of the center pivot axis operably connected to the transverse conveyor for controlling the pitch of the transverse conveyor.

5. The vehicle defined in claim 1, including an agitator positioned in the compartment for breaking up any of the bulk material bridging across sides of the compartment.

6. The vehicle defined in claim 5, wherein the agitator includes a beam rotatably supported at ends of the compartment and further includes radially-extending arms that engage the bulk material and still further includes a drive mechanism for rotating the beam.

7. A material-handling vehicle comprising:
a vehicle including a front-located control cabin;
an upwardly-open compartment on the vehicle for receiving and holding bulk material;
a longitudinal conveyor for motivating the bulk material toward a front of the vehicle;
a transverse conveyor at a front of the longitudinal conveyor for receiving the bulk material from the longitudinal conveyor and for selectively distributing the material laterally in right or left directions in patterns visible from the cabin;
structure for adjusting an angular position of the transverse conveyor; and
at least one guard attached to ends of the transverse conveyor and forming a tunnel over the ends to better direct and control bulk material being distributed by the transverse conveyor.

8. The vehicle defined in claim 7, wherein the at least one guard includes first and second guards each attached to the ends and spaced apart to define at least part of a side inlet opening to the transverse conveyor for receiving the bulk material from the longitudinal conveyor.

9. A material-handling vehicle comprising:
a vehicle including a front-located control cabin;
an upwardly-open elongated compartment on the vehicle for receiving and holding bulk material;
a longitudinal conveyor for motivating the bulk material toward a front of the vehicle;
a transverse conveyor at a front of the longitudinal conveyor for receiving the bulk material from the longitudinal conveyor and for selectively distributing the material laterally in right or left directions in patterns visible from the cabin;
structure for adjusting an angular position of the transverse conveyor; and
an agitator in the compartment for breaking up bulk material forming a bridge between sides of the compartment, the agitator including a rotatable beam spaced above a floor of the compartment and arms extending radially from the beam.

10. The vehicle defined in claim 9, wherein the agitator includes a drive mechanism positioned in a front of the vehicle.
